(19) United States
(12) Patent Application Publication
(10) Pub. No.: US 2009/0024733 A1
(43) Pub. Date: Jan. 22, 2009

(54) Apparatus for Mediation between Measurement, Biometric, and Monitoring Devices and a Server

(76) Inventor: Edward Shteyman, Jericho, NY (US)

Correspondence Address: WHITE-WELKER & WELKER, LLC, P.O. BOX 199, CLEAR SPRING, MD, 21722-0199, US

(21) Appl. No.: 11/778,132

(22) Filed: Jul. 16, 2007

(51) Int. Cl. G06F 15/173

(52) U.S. Cl. 709/224

(57) ABSTRACT

The present invention is a mediation apparatus between a server on a communication network and measurement, biometric, and monitoring devices, which, on their own, may or may not be capable to originate connections. Additionally, the mediation apparatus of the present invention can serve as an intermediate buffer for the data acquired from devices and as a source of control or processing data for devices. The present invention may be implemented either as a standalone device or built-in to a measurement device. Measurement devices may be of almost any type: biometric access control devices, security monitoring devices, physical access monitoring devices, various measurement devices, etc. The main function of mediation apparatus is a connection of measurement devices to the server through a communications network. In this arrangement the central server doesn't need to connect to devices directly. Instead, it periodically tries to connect to the server or constantly polls the server.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to a mediation apparatus for use in a network environment. More specifically the present invention relates to an apparatus for mediation between measurement, biometric, and monitoring devices and a server.

### BACKGROUND OF THE INVENTION

The present invention is used as a mediation apparatus (also known as an appliance) between a server on a communication network and measurement/biometric/monitoring devices, which, on their own, may or may not be capable to originate connections. Additionally, mediation apparatus can serve as an intermediate buffer for the data acquired from devices and as a source of control or processing data for devices. It is not necessary for the devices and the server to use the same network type and/or topology.

The mediation apparatus of the present invention allows for the use of various auto-configuration network protocols and may be configured independently from the devices and is used to traverse various types of firewall/filtering/proxy devices.

U.S. Pat. No. 7,069,028 teaches a mediation center apparatus that receives registration as answerers from mobile phones owned by answerers. The mediation center apparatus provides, responding to requests from a mobile phone owned by a questioner, candidate list information of suitable answerers among answerers who are registered in the mediation center apparatus, for the mobile phone. When the mediation center apparatus receives, from the mobile phone, information that instruct a selection of answerers, the mediation center apparatus establishes a circuit connection between the mobile phones owned by the selected answerer and the mobile phone owned by the questioner. A mediation consultancy service is provided by the answerer to the questioner by use of the circuit connection.

U.S. Patent Application 20040215785 teaches a mediation server that mediates a print demand from a client device to a printing device. In order to elude a firewall F/W set between the mediation server and the printing device, the printing device 300 first sends an HTTP request to the mediation server. The mediation server sends back an HTTP response including a print demand to the printing device. Encrypted communication may be established between the client device and the printing device according to the following procedure. The mediation server decrypts cipher data, which is encrypted with a public key by the client device, with a private key, re-encrypts the decrypted data with another private key, and mediates the encrypted data to the printing device. The printing device decrypts the encrypted data with the public key and carries out printing. This arrangement enables the printing device to carry out printing in response to a demand from the client device via respective secure network environments.

U.S. Patent Application 20050015812 teaches a method of distributing real time data streams across a multimedia network to receiving terminals, wherein a selected real time data streams is transmitted from a media server to a specific receiving terminals, wherein a mediation device is located between said media server and the receiving terminals, that a bi-directional communication with said media server is terminated at said media server for receiving data streams destined for the selected terminal and that said data streams are further forwarded to said selected terminal by means of a uni-directional communication protocol, and also a mediation device and a multimedia network therefore.

U.S. Pat. No. 6,816,493 teaches a low power consumption protocol for low power communication devices attached to an asynchronous network is described. In this protocol, a communication device is used as a high communication duty cycle Mediation Device (MD), thus permitting other communication devices to use a low communication duty cycle framing structure. The MD functions as a storage and retrieval service for messages between two devices when one device is not able to communicate. When the previously unavailable device becomes available, it can check in with the MD to retrieve any missed messages and respond to these messages accordingly. In a communication network, each of the low power communication devices can be configured to behave as MD's for a small amount of time. Sharing this responsibility among all communication devices in the network allows each device to maintain a low average communication duty cycle. This technique is applicable to a low power, low cost, zero-configuring, self-organizing, asynchronous network.

U.S. Pat. No. 6,880,105 teaches a method to develop a mediation device, which is used to convert first data to second data and vice versa. This mediation device is developed by using means to create a service that supports the mediation device functionality. This service is created by at first selecting predefined Service Independent Building Blocks, linking this selected predefined Service Independent Building Blocks together in a predefined order to create a service logic and adding subsequently the mediation device specific service data to the predefined Service Independent Building Blocks of the service logic. This last step finalizes the mediation device service. To, finally, realize a mediation device the created service is deployed by processing the service logic together with the service data.

Therefore it is an objective of the present invention to teach a mediation apparatus (also known as an appliance) between a server on a communication network and measurement/biometric/monitoring devices, which, on their own, may or may not be capable to originate connections.

It is another objective of the present invention to teach a mediation apparatus that can serve as an intermediate buffer for the data acquired from devices and as a source of control or processing data for devices.

It is yet another objective of the present invention to teach a mediation apparatus that allows for the use of various auto-configuration network protocols and may be configured independently from the devices and be used to traverse various types of firewall/filtering/proxy devices.

### SUMMARY OF THE INVENTION

The present invention is a mediation apparatus (also known and referred to as an appliance) between a server on a communication network and measurement, biometric, and monitoring devices, which, on their own, may or may not be capable to originate connections. The mediation apparatus may be implemented either as a standalone device or built-in to a measurement device.

Additionally, the mediation apparatus of the present invention can serve as an intermediate buffer for the data acquired from devices and as a source of control or processing data for devices. It is not necessary for the devices and the server to use the same network type and/or topology. The mediation apparatus of the present invention also allows use of various auto-configuration network protocols and may be configured independently from the devices and be used to traverse various types of firewall/filtering/proxy devices.

The present invention may be implemented either as a standalone device or built-in to a measurement device. Measurement devices may be of almost any type: biometric access control devices, security monitoring devices, physical access monitoring devices, various measurement devices, etc. The main function of mediation apparatus is a connection of measurement devices to the server through communication network. In this arrangement the central server doesn't need to connect to devices directly. Instead, the mediation apparatus periodically tries to connect to the server or constantly polls the server (if the underlying network supports only connectionless operations).

The mediation device of the present invention also contains a permanent memory for temporary storage (referred to as a “data buffer”) of different types of data that may be necessary for measurement processing and for general mediation apparatus functionality, or in case the connection to the central server is lost or its speed is not fast enough to keep up with incoming measurements. The mediation device may be connected to measurement devices through various network types, not necessary the same network types that are used for connection to the server. This allows mediation device to serve as a gateway to devices that are incapable to operate as a part of a centralized network.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart of the mediation apparatus of the present invention;

FIG. 2 is the apparatus structure of the present invention;

FIG. 3 is a flow chart illustrating the polling sequence of the present invention;

FIG. 4 is a flow chart illustrating the measurement result processing of the present invention;

FIG. 5 is a flow chart illustrating the server answer processing of the present invention; and

FIG. 6 is a flow chart illustrating the server polling processing of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

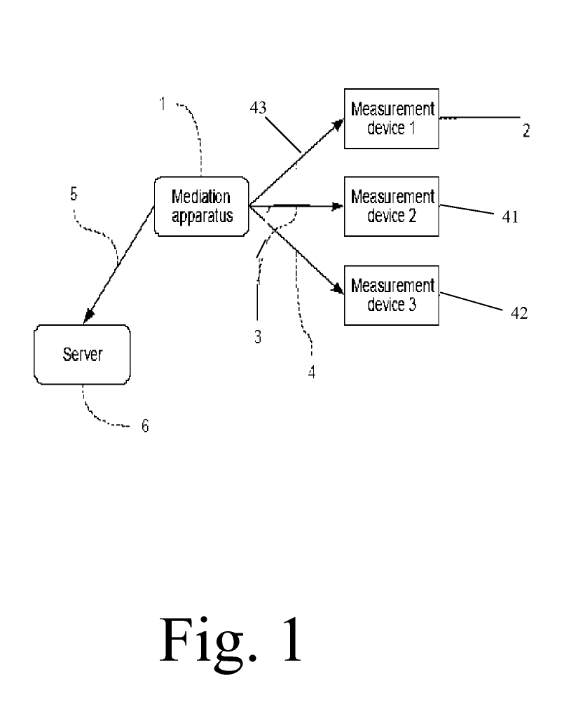

Now referring to FIG. 1, the general system overview is illustrated. The system consists of a central server 6, mediation apparatus (also referred to as “Appliance”) 1, connected to the server through a network 5 and one or more measurement devices 2, 41, and 42 connected to the mediation apparatus 1 through one or more network connections 3, 4, and 43.

Measurement devices 2, 41, and 42 and the central server 6 are not required to be connected to the mediation apparatus 1 through a specific type of network 5. For example, mediation apparatus 1 may be connected to a server 6 through TCP/IP protocol running on top of an Ethernet network and the measurement devices 2, 41, and 42 may be connected via RS-232 connections and UDP protocol on top of a modem PPP connection.

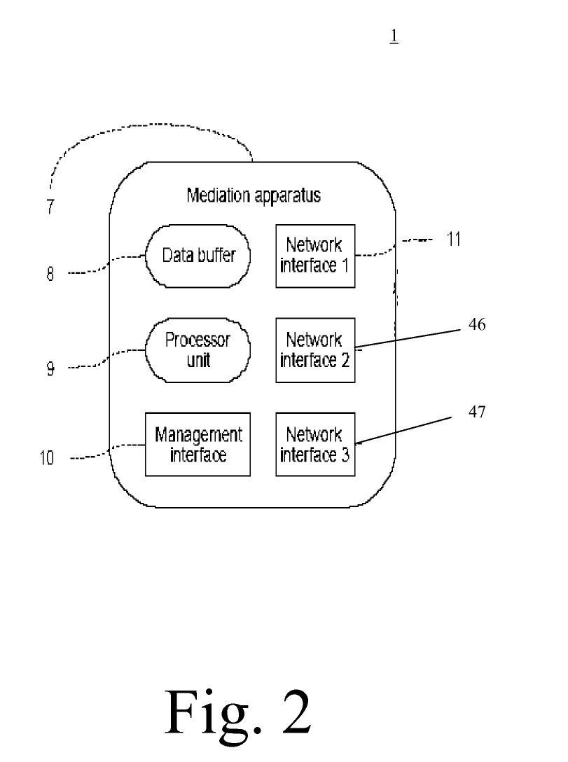

Now referring to FIG. 2, the general mediation apparatus structure is shown. The mediation apparatus 7 consists of, a self-contained central processing unit 9; a data buffer 8, which may be implemented as a file system on a non-volatile storage; an optional management interface 10 that may be used for administrative tasks such as initial setup or troubleshooting; and one or more network interfaces 11, 46, and 47.

The mediation apparatus 1 may contain any number of network interfaces 11, 46, and 47. Network interfaces 11, 46, and 47 are used to connect the mediation apparatus 1 to the measurement devices 2, 41, and 42 and to the central server 6. One or more measurement devices 2, 41, and 42 may be connected to a single network interface 11, 46, and 47, if the underlying network allows it. Similarly, the same network port may be used to connect to the measurement devices 2, 41, and 42 and to the central server 6.

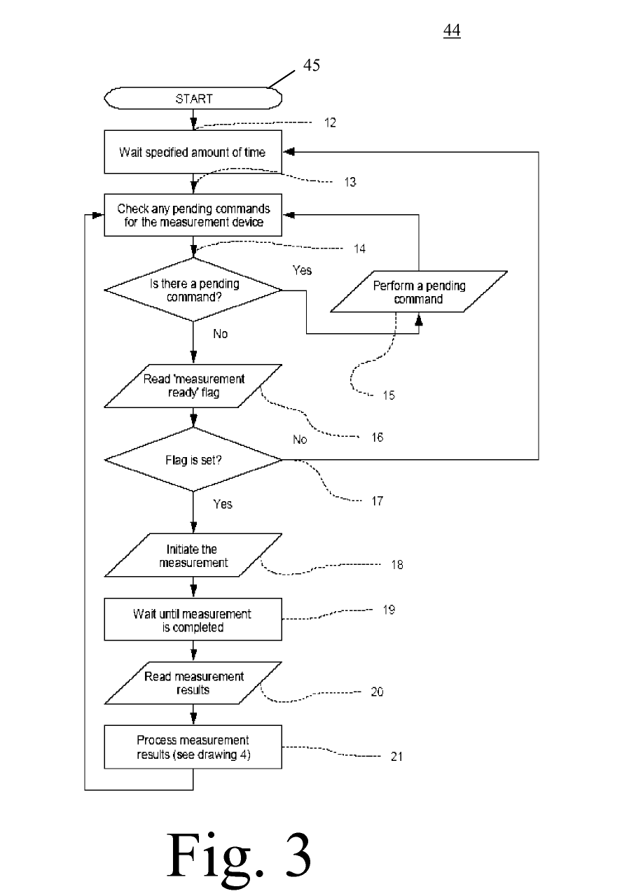

FIGS. 3, 4, 5, and 6 illustrate the control of the general mediation apparatus's functionality. Referring to FIG. 3, the mediation apparatus 1 regularly polls the measurement devices 44. The poll rate is regulated by delay time in the step 12 for ‘special event’ flag 14. For example, if the measurement device 1 is a biometric time attendance device, then this flag may be set when user initiates or starts 45 an authentication session by entering his or her ID using a keypad on the measurement device 1 or by using a smart card, barcode scanner or any other means of data entry.

The mediation apparatus 1, in response to this flag 14, initiates the measurement 18 and waits until the measurement is completed 19. In the case of a biometric device, an action may be the scanning of user's fingerprint, hand geometry, iris pattern, face recognition or speech recognition. The mediation apparatus 1 waits until the measurement is completed successfully or unsuccessfully 20. Upon completion, the measurement data is processed 21.

The mediation apparatus 1 also keeps a command queue for each measurement device; this command queue is checked 13 before polling for the ‘special event’ flag 14. Pending commands are then processed 15. This processing may result in the addition of one or more commands to the mediation apparatus' 1 pending command queues. When no additional commands are pending 14, the mediation apparatus 1 is then ready for measurement 16 and a ready for measurement flag is set 17.

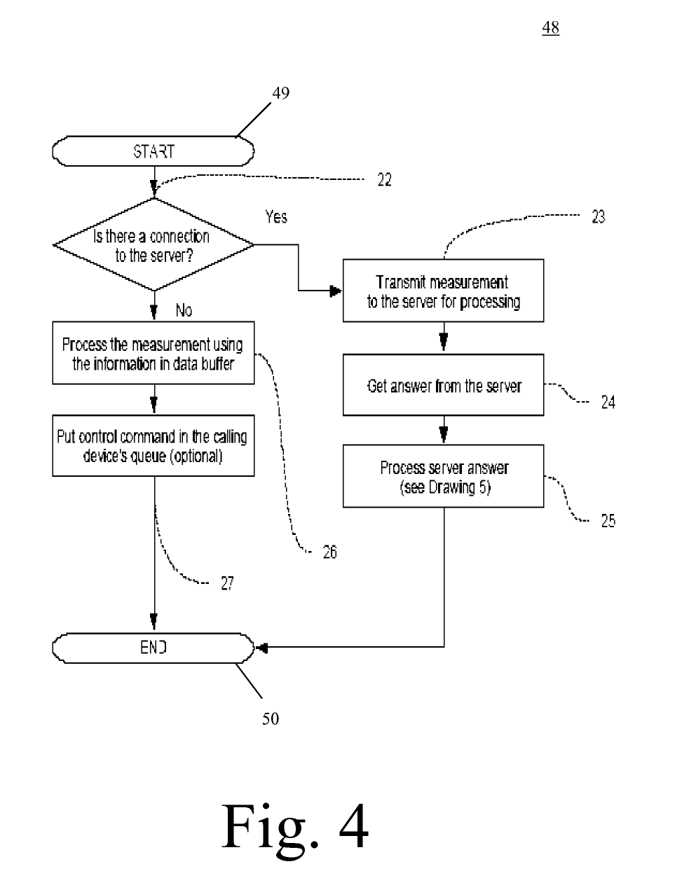

Now referring to FIG. 4, the measurement of result processing 48 is illustrated. There are two ways in which results may be processed: on the internal data in the data buffer 8 or by the central server 6 if there is an adequate and active network connection 5 between the mediation apparatus 1 and the central server 6.

One of the main advantages of the mediation apparatus 1 is its ability to work when there is no network connection 5 to the central server 6 or if the connection speed to the central server 6 is below the adequate speed needed for error free data transmission. The data buffer 8 may be used to store measurement results and to make decisions based on the measurement results. Once the process is started 49, the mediation apparatus 1 first determines if there is a connection to the central server 6 in step 22. If there is a connection, the mediation apparatus 1 transmits data to the server for processing in step 23, receives an answer from the server 24, and processes the server's answer 25 before finishing 50.

For example, a measurement device may be a biometric authentication device that is used to control access to a secure location. In this case the mediation apparatus 1 can compare the acquired biometric signature with the stored signature in the data buffer 8 and upon a successful match, make a decision to allow or deny access to the secure location.

If there is no connection, the mediation apparatus 1 processes the measurement using the information in the data buffer 8 in step 26 and puts a control command in the calling devices queue in step 27 before finishing 50.

As a result of the autonomous processing of steps 26 and 27, commands may be put into the device's pending commands queue during step 27. For example, in case of the biometric device, these commands may show a welcoming message to the user or disengage door-locking mechanisms to allow access to the secure zone.

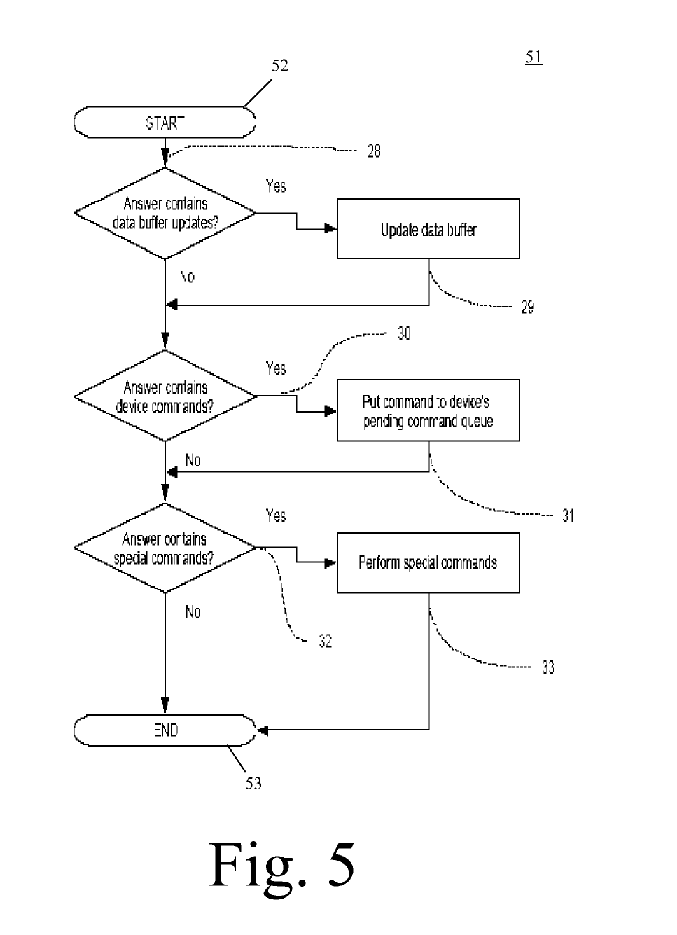

Now referring to FIG. 5, central server 6 answer processing 51 is illustrated. The central server 6 starts 52 by providing an answer that may contain data buffer synchronization information 28 and 29 or commands to be added to the device's pending commands queue 30 and 31. These commands may be used to control the measurement device's settings or to perform additional actions such as engaging or disengaging locks as in the case of biometric devices.

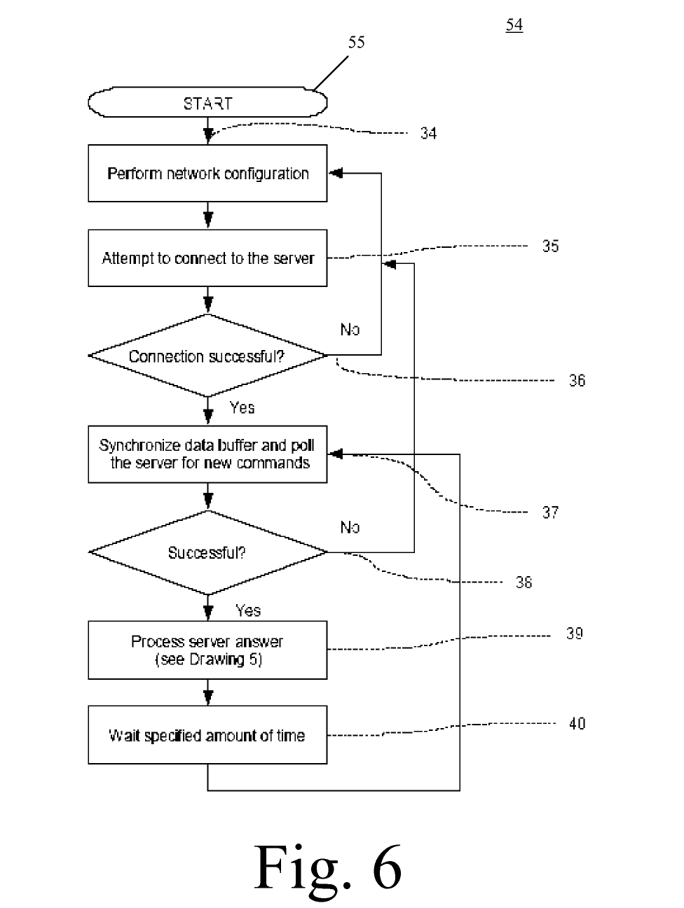

The central server 6 may send special commands 32 and 33 to perform miscellaneous actions such as updating the software on the apparatus, changing its setup, etc before ending its process 53. The mediation apparatus 1 must regularly poll the central server 6 or maintain connection to the central server 6, because the central server 6 is incapable of initiating the connections to the mediation device 1 on its own. The sequence of polling operations is illustrated in FIG. 6. Polling 54 of the central server 6 is performed simultaneously with the polling of the measurement devices.

Referring to FIG. 6, polling begins 55 with the network configuration 34, which uses automatic configuration protocols, whenever possible, supported by the underlying network and allowed in the apparatus configuration. For example, a device may use DHCP protocol, if it is connected to the server through TCP/IP protocol over the Ethernet network. Additionally, network configuration may be manually entered during the installation of the device.

After a successful connection attempt 35 and connection 36, the mediation apparatus 1 synchronizes its data buffer 8 with the central server 6 in step 37. For example, in the case of the biometric devices, the mediation apparatus 1 may upload the log of authentication attempts that took place while the mediation apparatus 1 had no network connection and was not connected to the central server 6.

After the successful process of data buffer synchronization 38 with the server, the mediation apparatus 1 processes the central server result set(s) 39 and continues with the polling loop after waiting a specified amount of time 40.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. An Apparatus for Mediation between Measurement, Biometric, and Monitoring Devices and a Server comprising:
a central server;
a mediation apparatus
a first network connecting said central server to said mediation apparatus;
and one or more measurement devices connected to said mediation apparatus through one or more additional network connections.

2. The Apparatus of claim 1 wherein
the mediation apparatus is connected to the server through TCP/IP protocol running on top of an Ethernet network, and
the measurement devices are connected via RS-232 connections and UDP protocol on top of a modem PPP connection.

3. The Apparatus of claim 1 wherein the mediation apparatus further consists of
a self-contained central processing unit;
a data buffer; and
one or more network interfaces.

4. The Apparatus of claim 3 wherein the mediation apparatus further consists of a management interface that provides means for enabling administrative tasks.

5. The Apparatus of claim 3 wherein the data buffer of the mediation apparatus if further comprised of a file system on non-volatile storage means.

6. The Apparatus of claim 3 wherein the network interfaces are used to connect the mediation apparatus to one or more measurement devices and to the central server.

7. The Apparatus of claim 3 wherein one or more measurement devices are connected to a single network interface.

8. The Apparatus of claim 7 wherein the single network interface also connects to one or more measurement devices and to the central server.

9. A method for mediation between measurement, biometric, and monitoring devices and a server, comprising
polling one or more measurement devices by a mediation apparatus connected to a central server that regularly polls the measurement devices for special event flags;
regulating the poll rate by delay time;
initiating a measurement and waiting until the measurement is completed;
processing measurement data by the mediation apparatus;
providing a pending command queue for each measurement device wherein said command queue is checked, before polling for a special event flag.
processing pending commands; and
entering a state of measurement readiness and setting an event flag when no additional commands are pending.

10. The method of claim 9 wherein the processing pending commands results in the addition of one or more commands to the mediation apparatus' pending command queues.

11. The method of claim 9 wherein measurement results are processed on the internal data in the data buffer of the mediation apparatus.

12. The method of claim 9 wherein measurement results are processed by a central server when there is an adequate and active network connection between the mediation apparatus and the central server.

13. The method of claim 11 wherein when there is no network connection to the central server or if the connection speed to the central server is below the adequate speed needed for error free data transmission, the data buffer stores measurement results and makes decisions based on the measurement results.

14. The method of claim 9 wherein
the mediation apparatus first determines if there is a connection to the central server,
if there is a connection, the mediation apparatus transmits data to the server for processing, receives an answer from the server, and processes the server's answer before finishing, or
if there is no connection, the mediation apparatus processes the measurement using the information in the data buffer and puts a control command in a calling devices queue before finishing.

15. The method of claim 9 wherein commands may be put into a measurement device's pending commands queue.

16. The method of claim 9 wherein
the central server provides an answer to the mediation apparatus that contains data buffer synchronization information or commands to be added to the device's pending commands queue; and
said commands are used to control the measurement device's settings or to perform additional actions.

17. The method of claim 16 wherein the mediation apparatus must regularly poll the central server or maintain connection to the central server, because the central server is incapable of initiating the connections to the mediation device on its own.

18. The method of claim 17 wherein a sequence of polling operations of the central server is performed simultaneously with the polling of the measurement devices.

19. The method of claim 18 wherein
polling begins with the network configuration;
synchronization between the mediation apparatus and its data buffer with the central server occurs after a successful connection attempt and connection;
processing of one or more of the central server result set(s) by the mediation apparatus occurs after the successful process of data buffer synchronization with the server; and
synchronization between the mediation apparatus and its data buffer with the central server continues the polling loop after waiting a specified amount of time.

20. The method of claim 18 wherein the network configuration uses automatic configuration protocols, supported by the underlying network and allowed in the apparatus configuration.
